(19) United States
(12) Patent Application Publication
(10) Pub. No.: US 2023/0098808 A1
(43) Pub. Date: Mar. 30, 2023

(54) GRINDING DISC RECEPTACLE

(71) Applicant: Franz Haimer Maschinenbau KG, Igenhausen (DE)

(72) Inventor: Franz Haimer, Igenhausen (DE)

(21) Appl. No.: 17/952,377

(22) Filed: Sep. 26, 2022

(30) Foreign Application Priority Data
Sep. 24, 2021 (DE) 10 2021 124 802.7

(51) Int. Cl. B24B 41/04

(52) U.S. Cl. CPC B24B 41/04

(57) ABSTRACT

The grinding disc receptacle has a rotationally symmetrical, hollow-cylindrical receptacle main body. A through-pipe, which is braced in particular in relation to the receptacle main body, is disposed in the cavity of the receptacle main body so as to be spaced apart from the cylinder barrel of the hollow-cylindrical receptacle main body.

### CROSS-REFERENCE TO RELATED APPLICATION

This application claims the priority, under 35 U.S.C. § 119, of German Patent Application DE 10 2021 124 802.7, filed Sep. 24, 2021; the prior application is herewith incorporated by reference in its entirety.

### FIELD AND BACKGROUND OF THE INVENTION

The invention relates to a grinding disc receptacle.

It is known that grinding is one of the subtractive manufacturing methods and is typically used in the field of precision machining and final machining of workpieces.

Since only a comparatively minor subtraction of material has been able to be historically achieved using classic, abrasive methods (for example in comparison to milling), advances have been made in the development of so-called high-performance milling in machine tools. As a result, subtraction of material that in some instances is 100 times to 1000 times higher in comparison to the classic grinding method can be generated (cf. German utility model DE 20 2017 000 560 U1).

Used for the grinding process are machine tools which are equipped with grinding tools, or else just grinding discs for short, that are held, or received, respectively, in grinding disc receptacles. While special grinding machines were used for this purpose in the past, the grinding process nowadays is more frequently carried out on milling machines, in particular when large and heavy workpieces are to be machined. Even surfaces that lie deep down and are difficult to access can be machined in one chucking operation by way of such milling machines. A prerequisite therefor are long-protruding grinding disc receptacles with great stiffness.

Such a grinding disc receptacle having received grinding disc is known from German utility model DE 20 2017 000 560 U1, for example.

Such a grinding disc receptacle here contains substantially a rotationally symmetrical, cylindrical receptacle main body, a grinding disc bearing on one end of the latter, and at least one clamping flange by means of which the grinding tool, or the grinding disc, respectively, is braced between the grinding disc bearing and the clamping flange.

On the other end of the receptacle main body the latter has an interface which establishes the connection between the grinding disc receptacle and a working/grinding spindle of a machine tool.

Coolant can be directed—from the working spindle-proximal interface to the grinding disc bearing—by way of an inner duct in the otherwise integrally configured receptacle main body.

The grinding disc receptable from DE 20 2017 000 560 U1 furthermore provides a damping element which is disposed in the interior of the receptacle main body and which is intended to damp vibrations caused by the abrasive machining of the workpiece.

In the case of fast-rotating components such as evident in particular in the case of machine tools during high-performance grinding, as described by DE 20 2017 000 560 U1 potential unbalanced masses in the tool system can indeed lead to immense vibrations in the tool system, or on the grinding tool, respectively, this inevitably leading to a deficient grinding result if attempts are now made to subtract material from the workpiece by using a grinding tool that vibrates in such a manner. In the worst case, this can also lead to damage to or destruction of the tool system.

DE 20 2017 000 560 U1 also establishes that vibrations of a magnitude as can arise in the field of high-performance grinding cannot be sufficiently attenuated even by way of such a damping element as provided in the document.

### SUMMARY OF THE INVENTION

It is an object of the invention to improve the grinding disc receptacles that are known in the prior art, in particular also to achieve a grinding disc receptacle which displays a positive damping behavior.

This object is achieved by a grinding disc receptacle having the features of the independent claim.

Advantageous refinements of the invention are the subject matter of dependent claims and of the description hereunder.

Potentially used terms such as top, bottom, front, rear, left or right, as well as inside or outside, unless explicitly otherwise defined, are to be understood in the customary sense. Terms such as radial and axial, to the extent used and not explicitly defined in a different way, are to be understood to relate to the central axis or symmetry axis or rotation axis, respectively, of the grinding disc receptacle described herein, or to the parts/components of the latter.

The term “substantially”, where used, may (in accordance with the understanding of the Supreme Court) be understood as meaning “to a practically still significant degree”. Possible deviations from exactness that are thus implied by this term may thus arise unintentionally (that is to say without any functional basis) owing to manufacturing or assembly tolerances or the like.

The grinding disc receptacle has a rotationally symmetrical, hollow-cylindrical receptacle main body. A through-pipe is disposed in the cavity of the receptacle main body, so as to be spaced apart from the cylinder barrel of the (hollow-cylindrical) receptacle main body, in particular disposed so as to be braced in relation to the receptacle main body.

The through-pipe is in particular disposed in the receptacle body so as to be rotationally symmetrical to and/or coaxial with the latter (or the central axis/symmetry axis/rotation axis thereof, respectively).

It is in particular also expedient for the through-pipe to be a coolant pipe, in particular a coolant pipe which is sealed in relation to the cavity. In this way, the through-pipe, or the coolant pipe, respectively, as part of a coolant supply system can direct coolant from one end of the receptacle main body (interface working spindle/grinding spindle), through the latter to the other end of the receptacle main body (grinding disc bearing/grinding disc).

The grinding disc receptacle according to the invention, as a result of the provided construction thereof, unifies a plurality of advantageous effects.

The modular construction of the receptacle, composed of a plurality of components that are able to be joined to one another, or are joined to one another, respectively, such as the receptacle main body and the through-pipe disposed in the cavity of the receptacle main body, and joints arising therefrom, thus has/have a damping effect, this being known as joint damping, in which energy is specifically dissipated at joints, or at the interfaces between components, respectively.

The hollow-cylindrical receptacle main body, which is hollow inside and is furthermore provided in the grinding disc receptacle, enables a noticeable reduction in weight (approximately 40%) of the grinding disc receptacle (in comparison to conventional grinding disc receptacles).

The bracing of the (inner) through-pipe in relation to the receptacle main body, which moreover is potentially also providable in the grinding disc receptacle, leads to a higher stiffness of the system.

In short, the grinding disc receptacle according to the invention is distinguished by a high degree of stiffness, a low weight, and a high damping effect.

According to one refinement it is provided that a thread is provided on one end of the through-pipe. A clamping shoulder, which causes the bracing with the receptacle main body, can be provided so as to be disposed on the other end, for example. It is particularly expedient for the clamping shoulder to have a cone (with a predefinable cone angle), (the latter being supported on a clamping shoulder having a complementary cone).

When the through-pipe can be screw-fitted in this way—similar to a long screw—and the axial position of the through-pipe can be adjusted/set in this way, the bracing of the through-pipe can thus be set (in a stepless manner) as a result.

Such a thread can be, for example, an external thread provided on the through-pipe (or an internal thread provided thereon). A complementary thread for the screw-fitting to the through-pipe can be disposed on the receptacle main body per se, or on a component such as a holder or through-pipe holder, respectively, or an insert (component) disposed in the receptacle main body.

An insulation that seals the interface between the through-pipe and the receptacle main body or the component/through-pipe holder, respectively, can also be provided on the screw-fitting location (or in the proximity of the latter). It is the task of such a seal (as also of similar seals on and about the through-pipe, as will be described hereunder) to prevent any ingress of coolant—from the through-pipe—as the coolant pipe—into the cavity of the receptacle main body.

This component, or the through-pipe holder, respectively, which is to be screwed to the through-pipe and is disposed on the receptacle main body, (while using pins) can be connected, for example, to the receptacle main body in particular in a rotationally fixed manner, for example pinned to the receptacle main body. A seal (see above) between the components can also be provided here.

According to one refinement it is furthermore also provided, for example, that a coolant supply pipe, which serves for supplying coolant, is connected, in particular screwed, to the through-pipe holder. A seal (see above) between the components can also be provided and be expedient.

As a refinement it can also be provided that a sleeve is disposed, in particular disposed in a sealed manner (see above), between the through-pipe and the through-pipe holder.

It can be expedient here for the sleeve to be pushed axially into a receptacle bore in the through-pipe holder (only freely), because a free axial displacement of the components is guaranteed in this way—when the through-pipe is axially adjusted (cf. setting the bracing, for example by way of the screw fitting).

The (mentioned) clamping shoulder which is provided on the other end of the through-pipe and is in particular configured so as to be conical, according to a refinement, is provided for bracing with the receptacle main body or with another component, such as a grinding disc bearing, that is connected to the receptacle main body and is supported on the latter (in a force-fitting manner).

This means that the through-pipe is supported on the receptacle main body (per se) or on the other component that is connected to the receptacle main body, or on the grinding disc bearing, the other component or the grinding disc bearing being screwed or pinned, for example, to the receptacle main body, as a result of which the bracing of the through-pipe in relation to the receptacle main body can thus be effected (directly/immediately or indirectly).

Interfaces/contact faces between the components can be sealed.

It can also be provided that the other component, or the tool grinding disc bearing, which can be screwed to the receptacle main body, for example, is also embodied so as to be integral to the receptacle main body. It can moreover also be provided that the grinding disc bearing is configured in multiple parts.

It is expedient for the grinding disc bearing to have at least one filler bore which opens into the cavity (of the hollow-cylindrical receptacle main body) and is in particular able to be closed by means of a closure screw. Damper materials or damping materials, or damping substances such as foams, for example aluminum foams, elastomers and the like (also described at a later stage), respectively, can be filled into the cavity by way of such a filler bore.

The bracing of the through-pipe (in relation to the receptacle body) by way of the clamping shoulder on the through-pipe can be expediently implemented by way of a corresponding cone (with a predefinable cone angle) on the through-pipe, for example as an external cone on an external circumference of the through-pipe. Cone angles can vary in wide ranges; for example, very steep cones with cone angle of approximately 40° to 60°, or else very flat cones with cone angle of approximately 5° to 20°, can be implemented.

A complementary counter shoulder/counter cone, on the receptacle main body or on the other part, or the grinding disc bearing, is to be expediently provided in a corresponding manner in this instance.

It is also expedient for a clamping flange, which is able to be screwed to the grinding disc bearing, to be provided for the grinding disc. The grinding disc can be braced (held) in this way so as to be disposed between the grinding disc bearing and the clamping flange.

A coolant bore, which extends axially through the grinding disc bearing and by means of which coolant can be directed (axially) through the grinding disc bearing, can expediently be provided in the grinding disc bearing.

Furthermore, a coolant bore, which extends axially through the clamping flange and which is in particular able to be closed by means of a closure screw, can also be provided in the clamping flange.

It can also be provided that radial coolant through-bores, which extend in particular from the axial coolant bore in the clamping flange to the external circumference (external circumferential face) of the latter, are provided in the clamping flange. In this way, coolant can be directed, through the clamping flange, up to the grinding disc.

Should the grinding disc per se moreover have pores, the tool can also be positively cooled in this way.

A sleeve, which is disposed on an interface between the through-pipe and the clamping flange between the through-pipe and the clamping flange and is in particular sealed (see above), can moreover also be provided, the sleeve being able to provide a—tight—transfer of coolant from the through-pipe to the clamping flange, or by way of the interface on the latter.

In order to be able to compensate for unbalanced masses of the system, it is furthermore expedient for bores for balancing screws to be disposed on an external circumferential face of the receptacle main body and/or the grinding disc bearing. Such bores (for balancing screws) can also be provided at other locations on the grinding disc receptacle.

The damping of the grinding disc receptacle can be furthermore increased in that at least one damping body, or an oscillatory mass, respectively, in particular a plurality or a multiplicity of damping bodies or oscillatory masses, respectively, is/are provided on the grinding disc receptacle.

In principle, such damping bodies on the grinding disc receptacle can be arbitrary, or variable in wide ranges, respectively, in terms of shape and/or material and/or location.

If the receptacle main body is provided according to the invention as a hollow-cylindrical pipe, it is thus in particular and preferably expedient for at least one damping body to be disposed in the cavity of the receptacle main body. (Alternatively, an external side on the receptacle main body may also be possible).

It can be expedient here for the at least one damping body to be an annular disc or a sleeve, in particular an annular disc or sleeve which has been pushed into the cavity, held, press-fitted and/or braced therein, in particular an annular disc or sleeve of plastics material, metal (optionally also a heavy metal, thus a metal which has a significantly higher density than steel, such as tungsten, for example) or rubber.

It can also be provided that the at least one damping body is a damping body which, in the cavity of the receptacle main body, from the cylinder barrel (of the receptacle main body) and/or from the through-pipe, in particular is held so as to be spaced apart by means of a ring, especially by means of a rubber or plastics ring, the damping body being in particular from a heavy metal or a plastics material.

It can in particular also be expedient for a plurality, in particular a multiplicity, of damping bodies which are disposed in the cavity to be provided.

As a refinement, it can in this instance also be provided that the plurality of, or the multiplicity of, respectively, damping bodies are annular discs which are held so as to be axially spaced apart by means of sleeves, and which are in particular held so as to be spaced apart from the cylinder barrel (of the receptacle main body) or from the through-pipe by means of rings, especially by means of rubber or plastic rings.

It can also be provided that the plurality of, or the multiplicity of, respectively, damping bodies are annular discs which bear directly on one another (“stack (formation)”).

An (already mentioned) damping material, in particular an elastomer or an (aluminum) foam, can also be incorporated in the cavity.

For the attachment to the working/grinding spindle it is expedient for the grinding disc receptacle to provide an interface for a grinding spindle, for example an HSC or a steep cone. However, other, non-standardized connection possibilities/interfaces can also be used. The interface here can be disposed integrally on the one end of the receptacle main body, or be disposed as a separate component on the receptacle main body. The interface per se can also be embodied integrally or in multiple parts for its part.

The description given hitherto of advantageous embodiments of the invention contains numerous features which are in some cases reproduced together in groups in the individual dependent claims. However, these features can expediently also be considered individually and combined to form other meaningful combinations.

Even if some terms are in each case used in the singular or in combination with a quantifier in the description and/or in the patent claims, there is no intention to restrict the scope of the invention to the singular or the respective quantifier in respect of these terms. Moreover, the words “a” and “an” should not be interpreted as quantifiers but as indefinite articles.

The above-described properties, features and advantages of the invention and the manner in which these are achieved will become more clearly and distinctly comprehensible in conjunction with the following description of the exemplary embodiments of the invention, which are explained in more detail in conjunction with the drawings/figures (identical parts/components and functions have the same reference signs in the drawings/figures).

The exemplary embodiments serve to explain the invention and do not limit the invention to combinations of features, not even in relation to functional features, indicated therein. Moreover, suitable features of any exemplary embodiment can also to this end be explicitly considered in isolation, removed from an exemplary embodiment, incorporated in another exemplary embodiment to supplement the latter and/or be combined with any one of the claims.

Other features which are considered as characteristic for the invention are set forth in the appended claims.

Although the invention is illustrated and described herein as embodied in a grinding disc receptacle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, sectional view of a grinding disc receptacle according to an embodiment according to the invention;

FIG. 1A is a sectional view of a fragment of the grinding disc receptacle according to the embodiment according to the invention as per FIG. 1, having the screw fitting of the grinding disc bearing to the receptacle main body;

FIG. 2 is a sectional view of the grinding disc receptacle according to an embodiment according to the invention;

FIG. 3 is a sectional view of the grinding disc receptacle according to an embodiment according to the invention;

FIG. 4 is a sectional view of the grinding disc receptacle according to an embodiment according to the invention;

FIG. 5 is a sectional view of the grinding disc receptacle according to an embodiment according to the invention;

FIG. 6 is a sectional view of the grinding disc receptacle according to an embodiment according to the invention;

FIG. 7 is a sectional view of the grinding disc receptacle according to an embodiment according to the invention; and

FIG. 8 is a sectional view of the grinding disc receptacle according to an embodiment according to the invention.

### DETAILED DESCRIPTION OF THE INVENTION

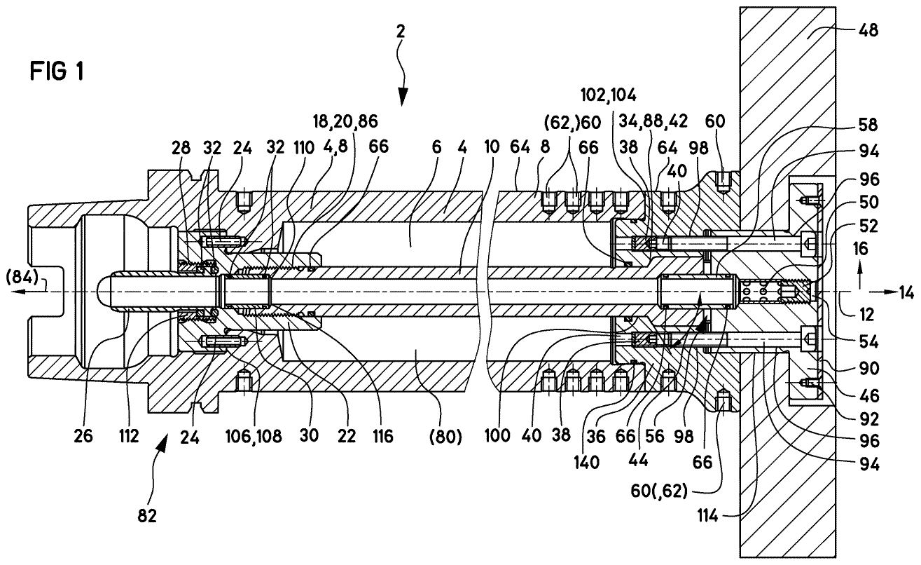

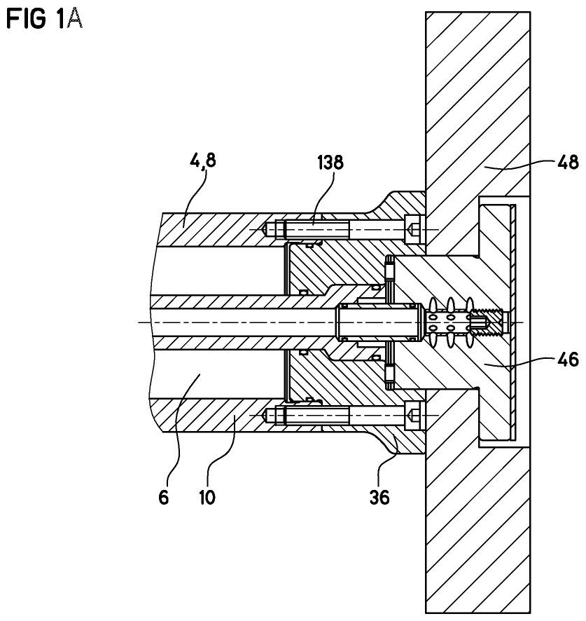

Referring now to the figures of the drawings in detail and first, particularly to FIGS. 1 and 1A thereof, there is shown a modular, or multiple-part, respectively, grinding disc receptacle 2.

The grinding disc receptacle 2 has a substantially rotationally symmetrical, hollow-cylindrical receptacle main body 4 (having a cylinder barrel 8).

A grinding disc bearing 36 is disposed on one end of this receptacle main body 4, so as to be screwed to the receptacle body 4 by means of screws 138 (cf. FIG. 1; FIG. 1A shows a cover-proximal fragment of the grinding disc receptacle 2 in a different (longitudinal) section which shows the screw fitting 136 of the grinding disc bearing 36 and the receptacle main body 4). As is shown in FIG. 1, a grinding disc 48 is (held) braced between the grinding disc bearing 36 and a clamping flange 46 so as to bear on or against the grinding disc bearing 36.

A cover 90 is screwed (92) to the clamping flange 46, the cover 90 covering a coolant bore 54 which in the center extends axially 14 through the clamping flange 46.

As is also shown in FIG. 1, the clamping flange 46 provides radially 16 running coolant bores 50 which extend from the central axial 14 coolant bore 54 radially 16 outwards to the external side 114 of the clamping flange 46.

The coolant bore 54, which in the center extends axially 14 through the clamping flange 46, on the cover side is closed by means of a closure screw 52.

The bracing of the grinding disc 48, between the clamping flange 46 and the grinding disc bearing 36, takes place by way of a screw fitting of the clamping flange 46 and the grinding disc bearing 36 by means of long screws 94, the latter extending through through-bores 96 in the clamping flange 46 into threads 98 (screwed there) in bores 40, so-called filler bores 40 (see hereunder for the purpose of the latter), in the grinding disc bearing 36.

A damping material such as, for example, an elastomer or an (aluminum) foam 80, (indicated as optional) can be filled into the cavity 6 of the (hollow-cylindrical) receptacle main body by way of these filler bores 40, which are able to be closed by means of closure screws 38, as is also shown in FIG. 1.

As is also shown in FIG. 1, different bores 60, in particular threaded bores, for balancing screws (62, not shown), are incorporated on the external circumferential face 64 of the receptacle main body 4 and the grinding disc bearing 36.

A through-pipe 10, here a coolant pipe 10, is disposed in the hollow-cylindrical receptacle main body 4, so as to be coaxial with the receptacle main body 4 (in terms of the central axis/symmetry axis/rotation axis 12), the through-pipe 10 proximal to the cover being held (braced—see hereunder for details) in a through-bore 100 in the grinding disc bearing 36, so as to be sealed (in relation to the grinding disc bearing) by an annular seal 66.

As is shown in FIG. 1, the coolant pipe 10 on the cover-proximal end thereof provides a conical clamping shoulder 34 (forming an external cone 42) which has a predefinable cone angle 44, for example of approximately 50°, and is braced in relation to a complementary clamping shoulder 88 in the through-bore 100 of the grinding disc bearing 36.

This bracing of the coolant pipe 10 and the grinding disc bearing 36 also has the effect that the grinding disc bearing 36, which is screwed (138) to the receptacle main body 4, by way of a flange 102 bears against or on the cover-proximal end side 104 of the receptacle main body 4 so as to be braced, or is drawn against the latter on the cover-proximal end side 104 of the receptacle main body 4, and the coolant pipe 10 is thus ultimately braced in relation to the receptacle main body 4, this imparting a high degree of stiffness to the system.

An annular seal 140 seals the contact area between the grinding disc receptacle 36 and the receptacle main body 4.

The (application of the) clamping force for the bracing (of the coolant pipe 10 and the grinding disc bearing 36, or the coolant pipe 10 and the receptacle main body 4, respectively) takes place by means of a screw fitting 20 on the other end of the coolant pipe 10.

For this purpose, the coolant pipe 10 there (on the other end) provides an external thread 18 that engages in an internal thread 86 of a through-pipe holder 22 which is connected in a rotationally fixed manner to the receptacle main body 4 (see hereunder for details), and by way of which the coolant pipe 10 is able to be screwed (screw fitting 20) into the through-pipe holder 22, more specifically into a through-bore 116 through the through-pipe holder 22 (thereon proximal to the cover). The axial screw travel determines (in a stepless manner) the pretension.

A seal 66 (in the form of an annular seal 66) between the coolant pipe 10 and the through-pipe holder 22 is also provided in the region of the screw fitting between the coolant pipe 10 and the through-pipe holder 22.

As is shown in FIG. 1, in the coolant pipe 10, proximal to the cover at the interface 56 between the coolant pipe 10 and the clamping flange 22 that lies in the interior of the grinding disc bearing 36, a sleeve 58 is furthermore inserted in the coolant pipe 10, (the sleeve 58 also being sealed (66) in relation to the coolant pipe 10), the other end of said sleeve 58 being received in the axial coolant bore 54 of the clamping flange 46 (also sealed here 66).

As is shown in FIG. 1, in the coolant pipe 10, at the end facing away from the cover-proximal end, a sleeve 30 is furthermore inserted into the coolant pipe 10 up to a detent 110, (the sleeve 30 also being sealed (32) in relation to the coolant pipe 10), the other end of said sleeve 30 being inserted in the through-bore 116 through the through-pipe holder 22, here however being axially free so as to guarantee a maximum axial screw travel. A seal 32, between the sleeve 30 and the through-pipe holder 22, is also provided here.

As is also shown in FIG. 1, the through-pipe holder 22 by way of a shoulder 106 disposed thereon is supported on a (counter) shoulder 108 in the interior of the receptacle main body 4. Pins 24 prevent twisting of the through-pipe holder 22.

FIG. 1 furthermore shows that a coolant supply pipe 26—on the end of the through-pipe holder 22 that faces away from the cover-proximal end—is connected (in a sealed manner 32) to the through-pipe holder, so as to be screwed by way of a sleeve 112.

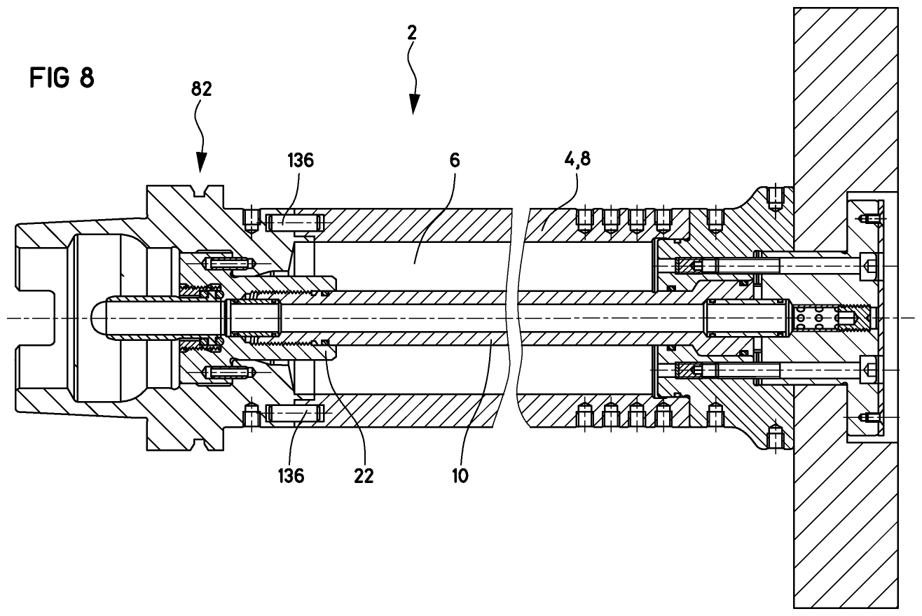

An interface 82, here an HSC 82, is (integrally) disposed on the other end, the grinding disc-proximal end, of the receptacle main body 4 on the receptacle main body 4, the interface 82 establishing the connection between the grinding disc receptacle 4 and a working spindle/grinding spindle (84, not shown) of a machine tool (cf. FIG. 8, it is highlighted here that the interface 82, which is integral to the receptacle main body 4, can also be embodied by a separate component 82, the latter optionally being connected in a rotationally fixed manner by means of pins 136 to the receptacle main body 4).

Coolant can be delivered up to the grinding disc 48 by way of the coolant supply pipe 26, the through-bore 116 in the through-pipe holder 22, the sleeve 30 that thereon faces away from the cover-proximal side, the coolant pipe 10, the cover-proximal sleeve 58 and the clamping flange 46 that contains the axial through-bore/coolant bore 54 and the radial coolant bores 50. Pores (not evident) in the grinding disc 48 can allow the coolant to enter the grinding disc 48. Seals (32, 66) described in the grinding disc receptacle 4, or on components thereon, respectively, prevent any ingress of the coolant into the cavity 6.

Alternatively or additionally thereto, the coolant from outside the grinding disc 48 can also be guided through radial bores in the grinding disc bearing 36 and/or the clamping flange 46 (not illustrated).

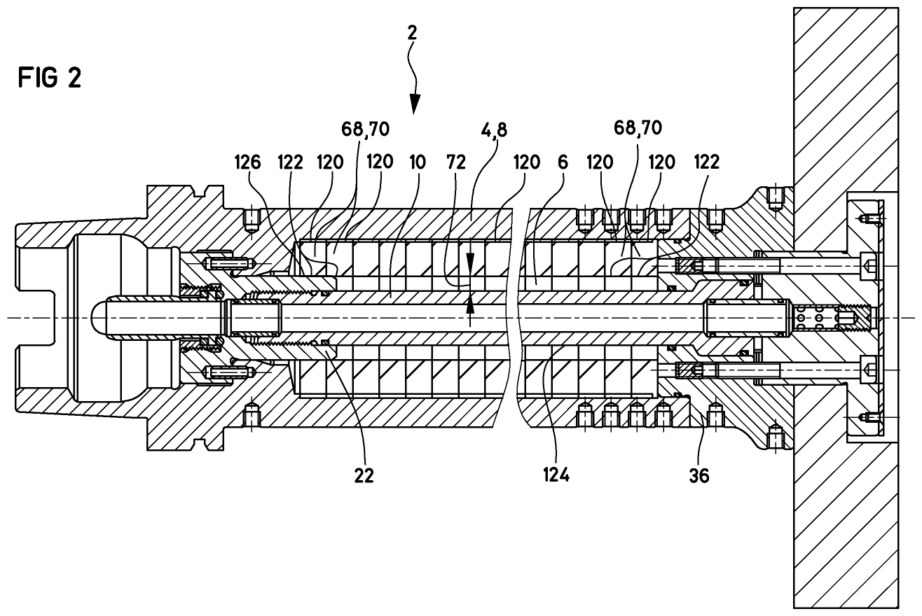

Modified and/or refined embodiments of the grinding disc receptacle 2 shown in FIG. 1 and described above are illustrated in FIGS. 2 to 8.

Since these embodiments of grinding disc receptacles 2 (as per FIGS. 2 to 8) correspond substantially to the (described) grinding disc receptacle 2 as per FIG. 1, repetitions of descriptions of identical, functionally equivalent components in the case of the further grinding disc receptacles 2 in FIGS. 2 to 8 will be dispensed with in the following descriptions. Only the modifications and refinements (in FIGS. 2 to 8) will be visualized hereunder.

FIG. 2 shows the grinding disc receptacle 2 as to how the latter is in terms of the damping behavior thereof is improved by additional damping elements 68.

As is shown in FIG. 2, a multiplicity of damping elements 68—in the form of annular discs 70—(disposed on one another in the manner of a stack) are situated in the interior of the cylinder barrel 8 of the receptacle main body 4.

These annular discs 70, by way of the external circumference 120 thereof in the cylinder barrel 8 of the receptacle main body 4, are press-fitted coaxially with the receptacle main body 4 and the through-pipe/coolant pipe 10, and (in the cavity 6 in the receptacle main body 4) extend substantially across the entire axial 14 length between the through-pipe holder 22 and the grinding disc bearing 36.

The internal circumference diameter 122 of the annular discs 70 corresponds substantially to an external circumference diameter 126 of the through-pipe holder 22—and (where the annular discs 70 do not sit on the through-pipe holder 22, cf. FIG. 2) allows a radial spacing 72 from the external circumference 124 of the coolant pipe 10.

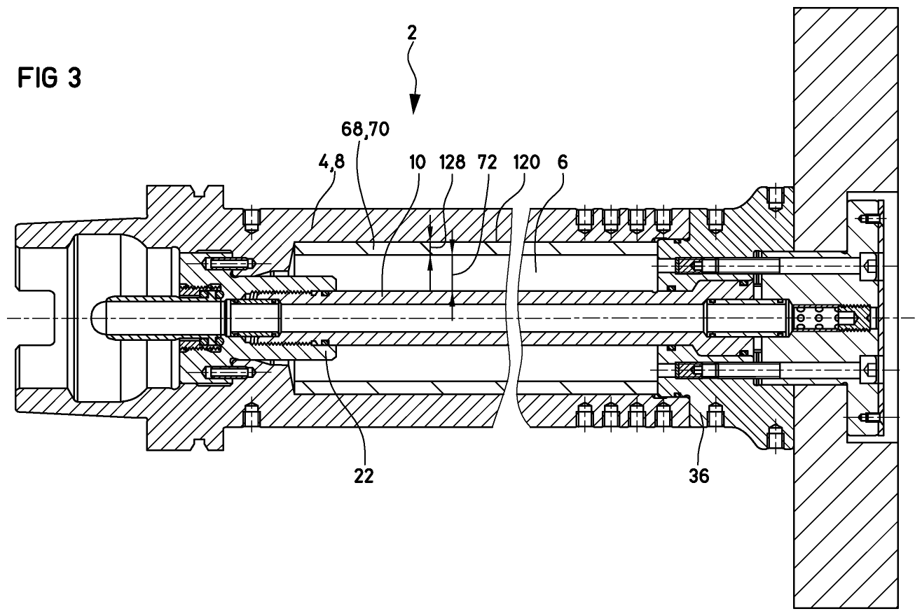

FIG. 3 shows the grinding disc receptacle 2 as to how the latter in terms of the damping behavior thereof is improved by another additional damping element 68.

As is shown in FIG. 3, a damping element 68—in the form of a sleeve 70—is situated in the interior of the cylinder barrel 8 of the receptacle main body 4.

This sleeve 70, by way of the external circumference 120 thereof in the cylinder barrel 8 of the receptacle main body 4, is press-fitted coaxially with the receptacle main body 4 and the through-pipe/coolant pipe 10, and (in the cavity 6 in the receptacle main body 4) extends substantially across the entire axial 14 length between the through-pipe holder 22 and the grinding disc bearing 36. The sleeve 70 can also be axially braced in the cavity 6 of the receptacle main body 4 by means of the grinding disc bearing 36.

The wall thickness 128 of the sleeve 70 is configured so as to be thin-walled such that a radial spacing 72 from the external circumference 124 of the coolant pipe 10 is configured.

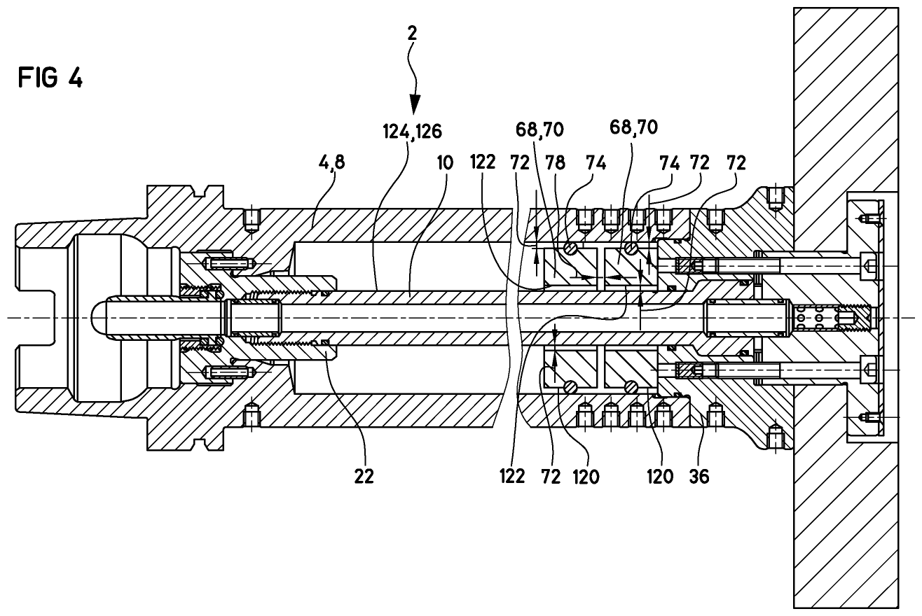

FIG. 4 shows the grinding disc receptacle 2 as to how the latter in terms of the damping behavior thereof is improved by again other additional damping elements 68.

As is shown in FIG. 4, two damping elements 68—in the form of annular discs 70—are situated in the interior of the cylinder barrel 8 of the receptacle main body 4.

These annular discs 70, by way of (rubber) rings 74 disposed on the external circumference 120 of said annular discs 70 at a radial spacing 72, are held in the cylinder barrel 8 of the receptacle main body 4—coaxially with the receptacle main body 4 and through-pipe/coolant pipe 10, specifically held (axially 14) on the grinding disc bearing-proximal end of the receptacle main body 4, so as to have a mutual axial spacing 78.

If the internal circumference diameter 122 of the annular discs 70 is larger than the external circumference diameter 126 of the through-pipe 10, the annular discs 70 thus also allow a radial spacing 72 from the external circumference 124 of the coolant pipe 10.

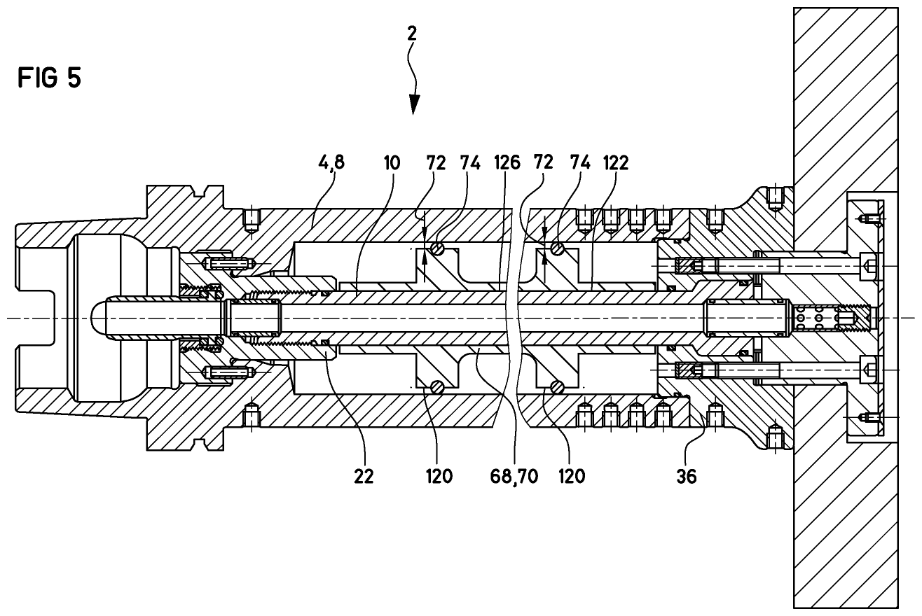

FIG. 5 shows the grinding disc receptacle 2 as to how—in this case—the latter in terms of the damping behavior thereof is improved by an additional damping element 68.

As is shown in FIG. 5, a damping element 68—in the form of a sleeve-shaped body 70, again referred to only also as the sleeve 70 for short—is situated in the interior of the cylinder barrel 8 of the receptacle main body 4.

This sleeve 70, by way of (rubber) rings 74 that are disposed on two axially spaced apart locations on the external circumference 120 of said sleeve 70 at a radial spacing 72, is held in the cylinder barrel 8 of the receptacle main body 4—coaxially with the receptacle main body 4 and the through-pipe/coolant pipe 10.

The internal circumference diameter 122 of the sleeve 70 is slightly larger than the external circumference diameter 126 of the through-pipe 10, as a result of which the sleeve 70 can be pushed onto the coolant pipe 10.

The sleeve 70 extends axially on the entire axial length between the through-pipe holder 22 and the grinding disc bearing 36, but may at both ends have in each case a clearance in relation to the through-pipe holder 22 and the grinding disc bearing 36.

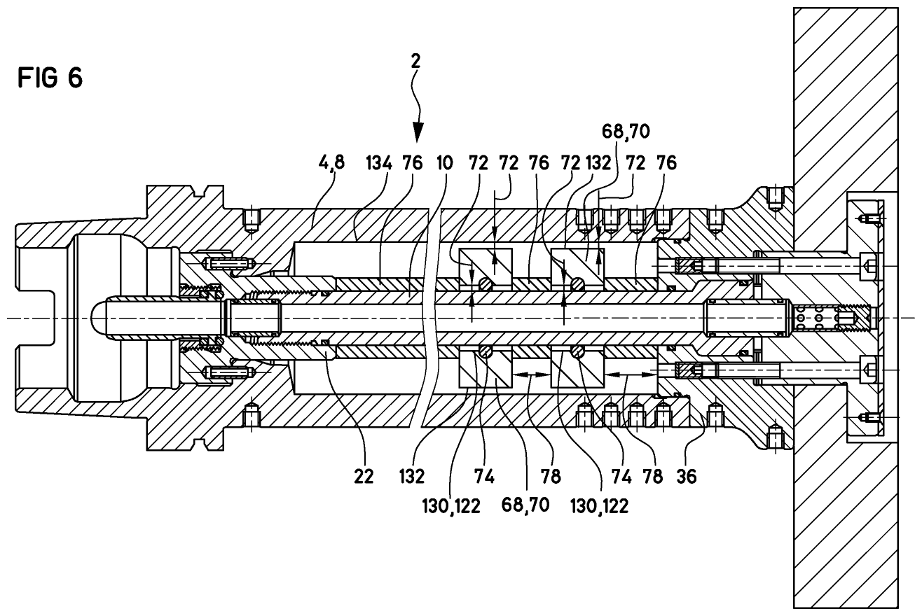

FIG. 6 shows the grinding disc receptacle 2 as to how the latter in terms of the damping behavior thereof is improved by—in this case two—additional damping elements 68.

As is shown in FIG. 6, in this case, two damping elements 68—in the form of annular discs 70—are situated in the interior of the cylinder barrel 8 of the receptacle main body 4.

These annular discs 70, by way of (rubber) rings 74 disposed on the internal circumference 130 of the annular discs 70 at a radial spacing 72, are held on the coolant pipe 10—coaxially with the receptacle main body 4 and the through-pipe/coolant pipe 10.

If the external circumference diameter 132 of the annular discs 70 is smaller than the internal circumference diameter 134 of the receptacle main body 4, or of the cylinder barrel 8 of the latter, respectively, the annular discs 70 thus also allow a radial spacing 72 from the receptacle main body 4.

The two annular discs 70 are held axially in position (by way of an axial spacing 78) by means of sleeves 76 which are disposed between and adjacent to said annular discs 70 and are pushed onto the coolant pipe, or disposed thereon, respectively, between the through-pipe holder 22 and the grinding disc bearing 36.

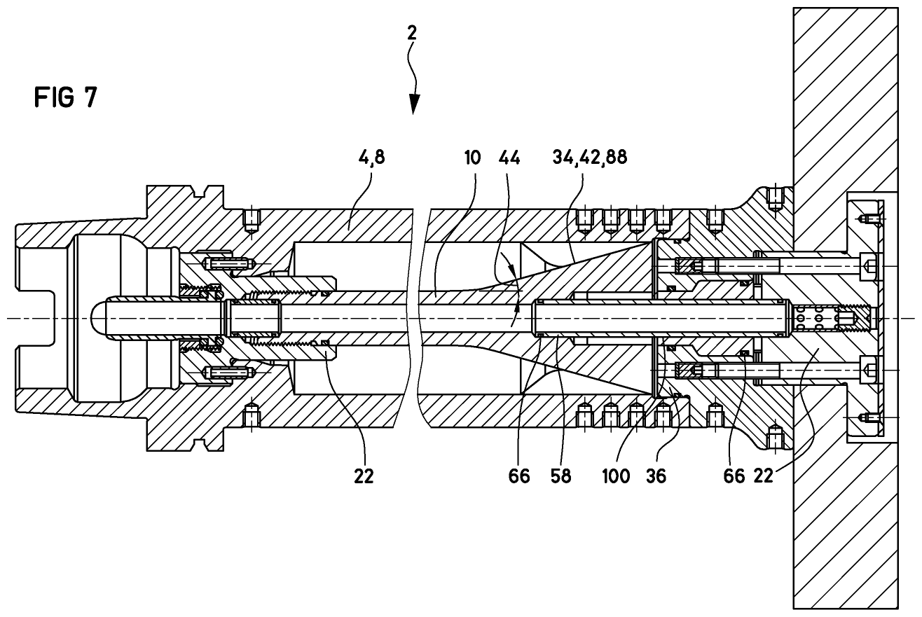

FIG. 7 shows the grinding disc receptacle 2—having a modified clamping contact or clamping faces, respectively, between, in this case, the coolant pipe 10 and the receptacle main body 4 (immediate direct bracing of the through-pipe 10 with the receptacle main body 4).

This means that the force flux of the bracing mechanism of the coolant pipe 10 into the receptacle main body 4 does not take place by way of the grinding disc bearing 36, but immediately and directly from the coolant pipe 10 to the receptacle main body 4.

As is shown in FIG. 7, the coolant pipe 10 to this end, on the cover-proximal end thereof, provides a conical clamping shoulder 34 (which forms a flat external cone 42) having a predefinable cone angle 44, here for example approximately 15°, the clamping shoulder 34 being braced in relation to a complementary clamping shoulder 88, in this case, on the receptacle main body 4.

The sleeve 58—between the coolant pipe 10, on the one hand, and the clamping flange 22, on the other hand—is thus guided through the bore 100 in the grinding disc bearing 36 and sealed there by means of a first seal 66, the bore 100 in this case being cylindrical and free of any shoulder/cone. The sleeve 58 is also sealed in relation to the coolant pipe 10 by means of a second seal 66.

FIG. 8 highlights that the interface 82, which as has been described above is configured integrally with the receptacle main body 4, can also be embodied by a separate component 82.

As is shown in FIG. 8, the separate interface 82 here is connected—in a rotationally fixed manner—to the receptacle main body 4 by pins 136.

If the interface 82 is thus provided as a separate component, it would also be possible (not shown) to provide the through-pipe holder 22 integrally on the interface (instead of a separate component), the embodiment of the interface 82 and the receptacle main body 4, which is separable as a result of the separate interface 82, guarantees adequate accessibility, the latter being required for the production and assembly of the grinding disc receptacle 2.

Although the invention has been illustrated and described in more detail using the preferred exemplary embodiments, the invention is not restricted by the disclosed examples and other variations can be derived therefrom without departing from the scope of protection of the invention.

The following is a summary list of reference numerals and the corresponding structure used in the above description of the invention:
2 Grinding disc receptacle
4 Receptacle main body
6 Cavity
8 Cylinder barrel
10 Through-pipe, coolant pipe
12 Central axis/symmetry axis/rotation axis
14 Axial, axial direction
16 Radial, radial direction
18 (External) thread
20 Screw fitting
22 Through-pipe holder
24 Pin, pin-fitted
26 Coolant supply pipe
28 Screwed, screw fitting
30 Sleeve
32 Seal
34 Clamping shoulder
36 Grinding disc bearing
38 Closure screw
40 Filler bore
42 (External) cone
44 Cone angle
46 Clamping flange
48 Grinding disc
50 Radial coolant bore
52 Closure screw
54 (Axially extending) coolant bore
56 Interface (through-pipe/clamping flange)
58 Sleeve
60 Bore (for balancing screw)
62 Balancing screw (not shown)
64 External circumferential face
66 Sealed, insulation (coolant pipe), annular seal
68 Damping body, damping/oscillatory mass
70 Annular disc, sleeve
72 (Radial) spacing, (radially) spaced apart
74 Ring
76 Sleeve
78 (Axial) spacing, (axially) spaced apart
80 Damping material, elastomer, (aluminium) foam
82 Interface, HSC, steep cone
84 Grinding spindle (not shown)
86 Internal thread (for 18/20)
88 (Complementary) clamping shoulder
90 Cover
92 Screw fitting (for cover)
94 Long screw
96 (Through-)bore
98 Thread
100 Through-bore (in the grinding disc bearing)
102 Flange
104 Cover-proximal end side of the receptacle main body
106 Shoulder (on the through-pipe holder)
108 (Counter) shoulder (for 106)
110 Detent
112 Sleeve
114 External side
116 Through-bore
120 External circumference
122 Internal circumference diameter (of 70)
124 External circumference
126 External circumference diameter (of 22 or 10)
128 Wall thickness
130 Internal circumference
132 External circumference diameter (of 70)
134 Internal circumference diameter (of 4/8)
136 Pin
138 Screw
140 Annular seal

1. A grinding disc receptacle, comprising:
a rotationally symmetrical, hollow-cylindrical receptacle main body having a cavity formed therein and a cylinder barrel; and
a through-pipe disposed in said cavity of said receptacle main body so as to be spaced apart from said cylinder barrel of said receptacle main body.

2. The grinding disc receptacle according to claim 1, wherein said through-pipe is disposed in said receptacle main body so as to be coaxial with said receptacle main body.

3. The grinding disc receptacle according to claim 1, further comprising a thread disposed on one end of said through-pipe on said through-pipe.

4. The grinding disc receptacle according to claim 1, further comprising a through-pipe holder disposed on said receptacle main body.

5. The grinding disc receptacle according to claim 4, further comprising:
a coolant supply pipe connected to said through-pipe holder; and/or
a sleeve disposed between said through-pipe and said through-pipe holder.

6. The grinding disc receptacle according to claim 1, further comprising:
a grinding disc bearing; and
a clamping shoulder for bracing with said receptacle main body or with said grinding disc bearing connected to said receptacle main body and disposed on another end of said through-pipe.

7. The grinding disc receptacle according to claim 1, further comprising a grinding disc bearing bracing said through-pipe and which is supported on said receptacle main body.

8. The grinding disc receptacle according to claim 1, further comprising a grinding disc bearing having at least one filler bore formed therein and said at least one filler bore opening into said cavity.

9. The grinding disc receptacle according to claim 6, wherein said clamping shoulder has an external cone.

10. The grinding disc receptacle according to claim 7, further comprising a clamping flange screwed to said grinding disc bearing, for a grinding disc.

11. The grinding disc receptacle according to claim 10, wherein said clamping flange has radial coolant through-bores formed therein and/or a coolant bore formed therein which extends axially through said clamping flange.

12. The grinding disc receptacle according to claim 10, further comprising a sleeve disposed on an interface between said through-pipe and said clamping flange.

13. The grinding disc receptacle according to claim 7, wherein at least one of said receptacle main body or said grinding disc bearing has an external circumferential face with bores formed therein for balancing screws.

14. The grinding disc receptacle according to claim 1, wherein said through-pipe is a coolant pipe.

15. The grinding disc receptacle according to claim 1, further comprising at least one damping body disposed in said cavity.

16. The grinding disc receptacle according to claim 15, wherein said at least one damping body is an annular disc or a sleeve.

17. The grinding disc receptacle according to claim 15, wherein said at least one damping body is a damping body which is held so as to be spaced apart from said cylinder barrel and/or from said through-pipe.

18. The grinding disc receptacle according to claim 1, further comprising a plurality of damping bodies disposed in said cavity.

19. The grinding disc receptacle according to claim 18, further comprising sleeves, said plurality of damping bodies are annular discs which are held so as to be axially spaced apart by means of said sleeves.

20. The grinding disc receptacle according to claim 1, further comprising a damping material is incorporated in said cavity.

21. The grinding disc receptacle according to claim 1, further comprising an interface for a working spindle disposed on one end of said receptacle main body so as to be integrally connected to said receptacle main body or so as to be connected as a separate component.
